(19) United States
(12) Patent Application Publication
(10) Pub. No.: US 2002/0071455 A1
(43) Pub. Date: Jun. 13, 2002

(54) Light-conductive fiber and method of producing a light conductive fiber

(76) Inventor: Frank Heine, Mainhardt (DE)

Correspondence Address: STRIKER, STRIKER & STENBY, 103 East Neck Road, Huntington, NY, 11743, US

(21) Appl. No.: 09/996,493

(22) Filed: Nov. 29, 2001

(30) Foreign Application Priority Data
Nov. 29, 2000 (DE) 1 00 59 314.3

(51) Int. Cl. H01S 3/30; H01S 3/00; H04B 10/12

(52) U.S. Cl. 372/6; 359/341.1

(57) ABSTRACT

A light-conductive fiber has a doped monomode core which extends substantially in a longitudinal direction of the fiber, a pump core which surrounds the monomode core and has a noncircular symmetrical cross-section, and at least one stress core which extends substantially in a longitudinal direction of the fiber and applies forces to the monomode core.

### BACKGROUND OF THE INVENTION

The present invention relates to a light-conductive fiber with a doped monomode core, which extends substantially in a longitudinal direction of the fiber, and a pump core which surrounds the monomode core, wherein the pump core has a non-circular-symmetrical cross-section.

The invention also deals with a method of producing a light-conductive fiber with a doped monomode core, which extends substantially in a longitudinal direction of the fiber, and a pump core which surrounds the monomode core, wherein the pump core has a noncircular symmetrical cross-section, wherein the monomode core is doped with an element from the group consisting of neodymium, erbium, thulium, holmium, ytterbium, and praseodym.

It is known to use such light-conductive fibers as laser fibers or amplifier fibers. For this purpose the fibers are doted with laser-active ions. Known applications of such fibers include for example the optical intersatellite communication.

The following different requirements are applied to such fibers:

it is desired to provide a high optical output power which is located above 100 mW or even above 10 W.

furthermore it is desired to provide a high channel separation in the high signal-to-noise ratio of the communication path.

furthermore it is required due to the special space conditions in the intersatellite communication, in which the fibers are utilized, to provide a resistance against a radioactive radiation.

Solutions have been already proposed to satisfy these requirements.

A high optical output power as well as the requirement for a high availability of the laser diodes required for optical excitation of the fibers are obtained on the basis of a double core pump concept. A laser with such a double core construction has a structure, in which a monomode core doped with an element of rare earth is surrounded by a noncircular-symmetrical pump core. It is multi-mode because of its numerous apertures and its diameter. The function of this pump core is that the excitation which must be coupled in the laser-active monomode core, is provided. In this manner it is possible to provide a high pump light power, while a coupling of a high excitation power is activated. As a result, high laser powers and amplification output powers are obtained. However, such systems receive unpolarized light. Since space applications use polarization filters for transmitting and receiving channel separation, the above described double core structures are not suitable for use in space applications.

It is known to impart a polarization property to fibers. This is achieved by introducing structures into the casing of the monomode fiber. Such structures are identified as stress cores. The stress cores have a different thermal expansion coefficient than the fiber material, (for example quartz glass), and thereby the voltage induced in the monomode core activates a double refraction of the monomode core. Thereby a polarization obtaining property is imparted to it.

A radiation endurance is especially important for the underwater communications and in particular for intersatellite connections. The radiation endurance is required for edge operations existing in terrestrial applications, to prevent radiation damage over the application time of several years. Such radiation damage leads to slow degradation of the performance up to loss of laser operation with respect to the amplification operation. Responsible for such worsening are the color centers in the fibers, or in other words such centers which absorb in a visible region and in a near infrared spectral region. By losing of electrons from the atoms of the laser materials or the amplifier materials, a worsening of the operational ability occurs. The lost electrons are no longer stationary and can be converter in other atoms in the material into long time stable centers which have wide band absorptions. The band width can amount to few hundredths nanometers. The light power absorbed in these centers is converted into heat and weakens the useful signal required for the laser operation or the amplifier operation.

Various changeable parameters for the manufacture of the fibers have to be considered, such as the pulling speed, the temperature and utilized initial materials. Furthermore, the influence of co-doping required for the adjustment of the refraction index profile must be tested, for example phosporus, germanium, and aluminum to the radiation resistance of the fiber. It has been determined that the use of phosphorus has a negative affect on the radiation endurance of fibers. In contrast, the old applications of germanium provide a reducing effect on the radiation damages. However, no general solutions exist for fibers which are doped with laser-active ions, when the accumulated radiation doses are in the region of 50 to 200 krad. These doses occur in space applications. A known solution for protecting optical fibers from radiation damages include codoping with chromium or with cerium. However, the existing solutions are not satisfactory for producing a fiber which provides satisfactory results with respect to the above mentioned criteria.

### SUMMARY OF THE INVENTION

Accordingly, it is an object of the present invention to provide a light-conductive fiber and method of producing a light conductive fiber, which avoid the disadvantages of the prior art.

In keeping with these objects and with others which will become apparent hereinafter, one feature of the present invention resides, briefly stated, in a light-conductive fiber, comprising a doped monomode core which extends substantially in a longitudinal direction of the fiber; a pump core which surrounds said monomode core and has a noncircular symmetrical cross-section; and at least one stress core which extends substantially in a longitudinal direction of the fiber and applies forces to said monomode core.

The invention provides a fiber in which at least one stress core is provided, which extends substantially in a longitudinal direction of the fiber and which applies forces to the monomode core. It includes a combination of a doped monomode core, a pump core having a noncircular symmetrical cross-section, and a polarization obtaining stress core. Thereby both high powers are provided, and furthermore a good channel separation and a good signal-to-noise ratio of a communication path is provided due to the polarized emission of the light.

Preferably, the stress core surrounds the monomode core. The fiber in cross-section has a structure with an inwardly located monomode core, a first region which surrounds the monomode core and formed as a stress core, and a second region which surrounds the monomode core and the stress core and acts as a pump core. This further region is then embedded by the remaining fiber material.

It is however also possible to provide two stress cores which do not surround the monomode core. The monomode core is thereby directly surrounded by a region which is a part of the pump core, while the stress core is embedded partially or completely in the pump core. Such a construction of the inventive fiber is exceptionally flexible.

It can be advantageous when the at least one stress core has a substantially oval cross-section. Such a construction is preferable when the stress core surrounds the monomode core, since the geometry of the required forces leading to the polarization in this way are transferred to the monomode core.

It can be also advantageous when at least one stress core has a substantially circular cross-section. Such a circular cross-section is preferable when the stress core does not surround the monomode core or imbed. For example, the circular stress core is arranged diametrically opposite with the monomode core in the center between the stress cores.

It can be also provided that the at least one stress core has a multi-cornered cross-section. Also in this embodiment separate stress cores are preferable, which do not directly surround or embed the monomode cores. Moreover, a diametrically opposite arrangement with an intermediately located monomode core is possible.

In accordance with a preferable embodiment of the invention, the refraction index of the at least one stress core is smaller or equal to the refraction index of the pump core. Such a relative value of the refraction indexes is especially advantageous when the stress core does not surround the monomode core. With such a relative values, the pump light is caught in the stress cores, so that it can not reach the monomode core.

On the other hand it is advantageous when the refraction index of the at least one stress core is greater than the refraction index of the pump core. This is especially useful when the stress core surrounds directly the monomode core. In this way the pump light is concentrated on a narrow region around the monomode core, which is advantageous for excitation of the monomode core.

Preferably, the at least one stress core has a thermal expansion coefficient which is different from the thermal expansion coefficient of the fiber material. The provisional different thermal expansion coefficients is a suitable means to induce in the monomode core a voltage which provides a double refraction. In this way the polarization obtaining properties are available.

Preferably, the product of pneumatical apertures and diameter of the pump core is greater or equal to the product of numerical apertures and diameter of a pump light source. In this way the pump power can be efficient coupled into the pump core.

It is especially advantageous when the pneumatic apertures of the pump core amount to approximately 0.22 and the diameter of the pump core amounts to approximately 100 μm. Such values are recommended both in view of their geometrical expansion and also with respect to laser or amplifier properties.

Preferably the monomode core is doped with at least one element selected from the group consisting of neodymium, erbium, thulium, holmium, ytterbium, and presidium. All these laser-active substances can be used within the frame of the present invention.

Furthermore, as an initial material for the fiber, quartz glass or fluoride glass can be used. In some cases the initial materials can be selected in a flexible manner without departing from the spirit of the present invention.

It is especially advantageous when the fiber in accordance with the present invention has a codoping with cerium. Such a codoping provides a special radiation insensitivity for the fiber, which is especially important for the underwater communications and for intersatellite connections.

It is especially advantageous when the monomode core has a codoping with cerium. This provides a radiation insensitivity in particular of the next surrounding of the laser-active regions, which is very useful for the long term operation.

It can be however advantageous when the at least one stress core has a codoping with cerium. Also in this manner the long term stability of the fiber in condition of increased radiation loading is improved.

The present invention also deals with a method, in which in the fiber at least one stress core is introduced, which extends substantially in a longitudinal direction of the fiber, and which applies forces to the monomode core. Therefore, a combination is provided of a doped monomode core, a pump core having a noncircular symmetrical cross-section and a polarization obtaining stress core. Thereby both high powers are available, and furthermore a good channel separation and a good signal-to-noise ratio of a communication path is provided due to the polarized emission of the light.

Preferably for adjusting a refraction profile, a quartz fiber with aluminum is utilized. This generally known process can be advantageously used for the present invention.

It is advantageous when the doping is provided with Yb₂O₃. With selection of a suitable concentration of Yb₂O₃, for example 0.6 mol %, a doping concentration is obtained, which is advantageous for the laser or amplifier operation.

Furthermore, in the inventive method it is possible that a codoping with Ce₂O₃ is performed. In this manner the desired increased resistance against radiation is obtained. It is especially useful when for example a concentration of Ce₂O₃ of 0.24 mol % is used. In connection with this it should be mentioned that a doping ability with cerium is practically always provided, since cerium originates from the same chemical group as the laser active ions.

In the invention therefore includes the use of the inventive fiber as a power amplifier for light with wavelength of approximately 1064 nm in the optical intersatellite communication. Such application of the power amplifier which is provided in the transmission part of communication satellites provides all advantages of the present invention.

The invention is based on a surprising recognition that both an improvement of the radiation endurance and a polarization preservation can be provided in a fiber with a doped monomode core and a pump core by corresponding new features. Because of one or several stress cores with the suitable optical properties, a polarization preservation is provided, wherein the high intensities of a system with monomode core and pump core are available. By a suitable geometrical shape of the stress core the pumping properties are further improved. Corresponding regions of the fiber can be doped with cerium, which leads to an improved radiation endurance which plays an important role especially for the underwater communications and for intersatellite connections.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a section of a first embodiment of a fiber of the prior art;

FIG. 2 is a view showing a section of a second embodiment of a fiber of the prior art;

FIG. 3 is a view showing a section of a third embodiment of the fiber of the prior art;

FIG. 4 is a view showing a section of a fourth embodiment of the fiber of the prior art;

FIG. 5 is a view showing a section of a fifth embodiment of fiber of the prior art;

FIG. 6 is a view showing a section of a fiber in accordance with the present invention; and

FIG. 7 is a view showing a diagram illustrating the present invention.

### DESCRIPTION OF THE PREFERRED EMBODIMENTS

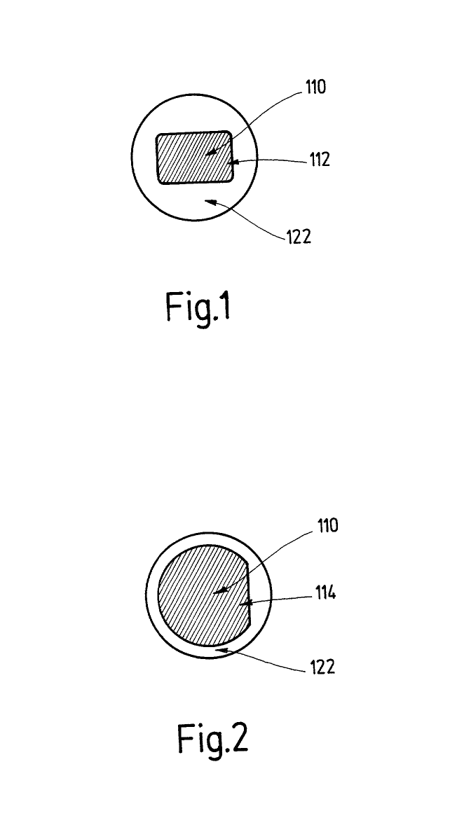

A cross-section of the fiber in accordance with the prior art is shown in FIG. 1. A doped monomode core 110 is located in the center of the fiber. It is surrounded by a pump core 112. Both cores are embedded in an outer casing 122. The monomode core 1 10 is doped with an element of the rare earths. The pump core 112 is arranged noncircular symmetrical around the monomode core 110. Due the numeric apertures of the pump core and its diameter, it is multimode. The pump core 112 guides the excitation light which must be coupled in the laser-active monomode core 110. The provision of a pump core 112 has the advantages. In conventional monomode fibers the pump light is guided only in the monomode core. Thereby the coupling of high excitation powers is not possible. In the fibers shown in FIG. 1 to the contrary because of the specially designed pump core 112, a high power can be coupled.

FIG. 2 shows a cross-section of a further embodiment of a fiber of the prior art. Here the monomode core 110 is surrounded by a pump core 114 which is different from the pump core 112 of FIG. 1. Moreover both cores, both the monomode core 110 as well as the pump core 114, are embedded in an outer casing 122. Also, the pump core 114 in FIG. 2 is noncircular symmetrical. The basic operation of the fiber shown in FIG. 2 is comparible with the basic operation of the fiber of FIG. 1.

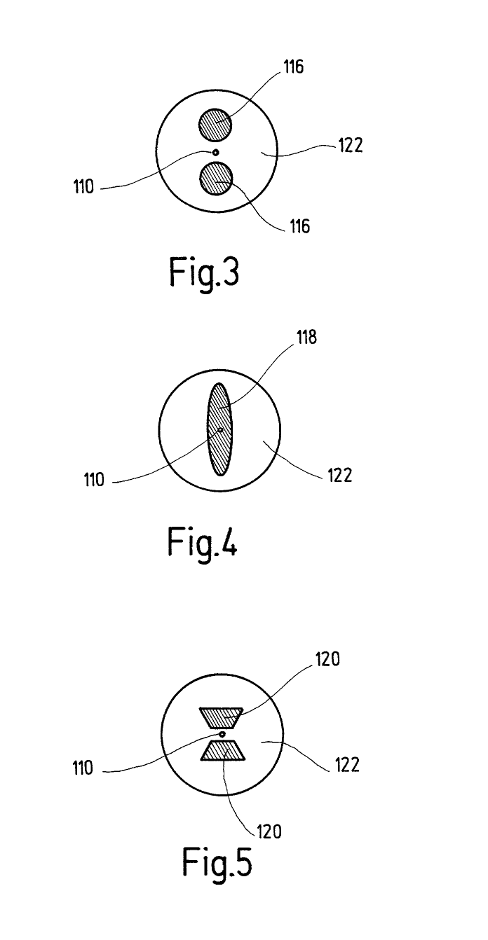

FIG. 3 shows a cross-section of the third embodiment of a fiber of the prior art. In this case no pump core is provided. Moreover, the monomode fiber is directly embedded in the outer casing 122 of the fiber. On two diametrically opposite sides of the doped monomode core 110, stress cores 116 are arranged. These stress cores have a different thermal expansion coefficient than the fiber material. The voltage induced thereby in the monomode core 110 causes a double refraction of the monomode core 110, whereby it operates for polarization preservation.

FIG. 4 shows a cross-section of a fourth embodiment of a fiber in accordance with the prior art. The monomode core 110 is here directly surrounded by the oval stress core 118, wherein the system of the monomode core 110 and the stress core 118 is embedded in the outer casing 122 of the fiber. Furthermore, a polarization preservation is realized due to the action of the stress core 118 on the monomode core 110.

FIG. 5 shows a fifth embodiment of a fiber in accordance with the prior art. The arrangement in accordance with FIG. 5 is comparible with the arrangement of FIG. 2. In contrast to FIG. 3 however, stress cores 120 are provided with a trapezoidal cross-section. The doped monomode core 110 is again directly embedded in the outer casing 122 of the fiber.

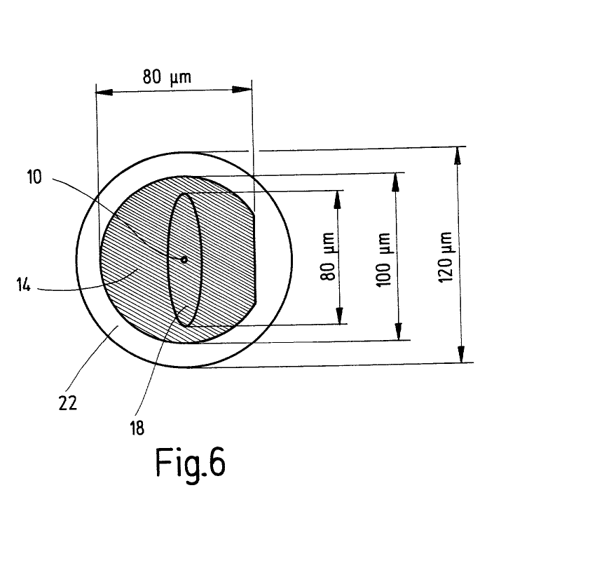

FIG. 6 shows a cross-section of an inventive fiber. The doped monomode core 10 extends in the center of the fiber and is surrounded by an oval stress core 18. This system is arranged in a pump core 14 with noncircular symmetrical shape. The whole system of the monomode core 10, the stress core 18, and pump core 14 is surrounded by the outer casing 22 of the fiber. The shown dimensions are only exemplary. In some cases the concrete shape of the pump core 14 and the stress core 18 is only exemplary. Further examples of possible arrangements can include any combinations of the structures shown in FIGS. 1-5. The fiber in accordance with FIG. 6 can be pumped with a high power, since a pump core 14 is provided. Furthermore, a polarization preservation is obtained by the introduction of the stress core 18.

For the geometry of the design, it should be considered that the product of numerical apertures and core diameter of the pump core 14 must be greater or equal to the product of numerical apertures and the diameters of the pump source, so as to provide in this manner efficient coupling of the pump power in the pump core 14. A possible combination for example includes both the pump light source and the pump core with a numerical aperture of 0.22 and furthermore both the pump light source and the pump core with a diameter of 100 μm.

In FIG. 6 requirements for the diffraction indices of the corresponding regions are satisfied. In the embodiment of FIG. 6, in which the stress core 18 surrounds the monomode core, it is important when refraction index of the stress core 18 is greater than the refraction index of the pump core 14. In this way light is concentrated on a narrow region around the monomode core, which is useful for coupling of the light. On the other hand, the conditions when the monomode core 10 is not directly surrounded by a stress core, in other words when for example a structure of FIG. 3 or FIG. 5 with respect to stress core can be provided. In this case the refraction index of the stress core embedded in the pump core is not greater than that of the pump core, since otherwise pump light would be caught in the cores. Therefore it can reach the monomode core.

Preferably, the monomode core 10 is codoped with cerium. Thereby the fiber is resistant against radiation, in particular radio active radiation and radiation by protons or electrons. For example, an inventive fiber is produced so that a codoping with 0.24 mol % Ce₂O₃ is performed to a doped quartz fiber with 0.6 mol % Yb₂O₃. The quartz fiber is provided with aluminum for adjustment of the refraction profile.

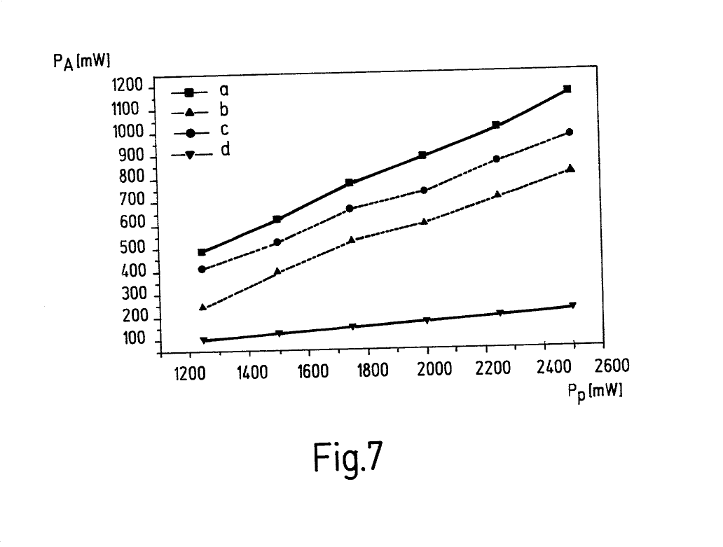

FIG. 7 shows a diagram in which the initial power P _{A} is plotted against the pump power P _{P}. The measuring point identified as a shows the power efficiency of a non radiated ytterbium fiber codoped with cerium. The measuring point identified with b shows the power efficiency of the ytterbium fiber codoped with cerium. The measuring points identified as c show the efficiency of a non radiated ytterbium fiber codoped with cerium. Measuring points identified with d show the power efficiency of a non radiated ytterbium fiber not codoped with cerium. The measuring points identified with z show the power efficiency of a radiated ytterbium fiber not codoped with cerium. The radiation before the receipt of the measuring points b and d is provided with correspondingly 100 kRAD Gamma (Co⁶⁰). With the fiber codoped with cerium a return of the initial power of a fiber amplifier is approximately 70% of the initial power measured before the radiation. A comparible fiber not codoped with cerium (the same compensation but without cerium) to the contrary after the irradiation can no longer operate as an amplifier, since the dampening induced by color sensors is too high. The return of the efficiency is approximately 20% of the same of the non radiated fiber.

The doping concentration of cerium can be located in a broad region with respect to the doping concentration of the laser-active ions. For example codoping between 5% and 100% of the doping concentration of the laser-active ions is possible. By the doping of the stress core with cerium, an improvement is possible since the production of the color sensors can be also voided in the stress course.

It will be understood that each of the elements described above, or two or more together, may also find a useful application in other types of constructions differing from the types described above.

While the invention has been illustrated and described as embodied in light-conductive fiber and method of producing a light conductive fiber, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A light-conductive fiber, comprising a doped monomode core which extends substantially in a longitudinal direction of the fiber; a pump core which surrounds said monomode core and has a noncircular symmetrical cross-section; and at least one stress core which extends substantially in a longitudinal direction of the fiber and applies forces to said monomode core.

2. A light-conductive fiber as defined in claim 1, wherein said stress core surrounds said monomode core.

3. A light-conductive fiber 1; and further comprising an additional stress core, said stress cores being arranged so that they do not surround said monomode core.

4. A light-conductive fiber as defined in claim 1, wherein said at least one stress core has a substantially oval cross-section.

5. A light-conductive fiber as defined in claim 1, wherein at least one stress core has a substantially circular cross-section.

6. A light-conductive fiber as defined in claim 1, wherein said at least one stress core has a multi-cornered cross-section.

7. A light-conductive fiber as defined in claim 1, wherein said at least one core has a refraction index which is at most equal to a refraction index of said pump core.

8. A light-conductive fiber as defined in claim 1, wherein said at least one stress core has a refraction index which is greater than a refraction index of said pump core.

9. A light-conductive fiber as defined in claim 1, wherein said at least one stress core has a thermal expansion coefficient which is different from a thermal expansion coefficient of a fiber material.

10. A light-conductive fiber as defined in claim 1, wherein a product of a numerical aperture and a diameter of said pump core is at least equal to a product of a numerical aperture and a diameter of a pump light source.

11. A light-conductive fiber as defined in claim 1, wherein a numerical aperture of said pump core amounts to substantially 0.22, while a diameter of said pump core amounts to substantially 100 μm.

12. A light-conductive fiber as defined in claim 1, wherein said monomode core is doped with at least one element selected from the group consisting of neodymium, erbium, thullium, holmium, ytterbium and praseodym.

13. A light-conductive fiber as defined in claim 1, wherein an initial material of the fiber is a material selected from the group consisting of a quartz glass and a fluoride glass.

14. A light-conductive fiber as defined in claim 1, wherein the fiber has a codoping with cerium.

15. A light-conductive fiber as defined in claim 14, wherein said monomode core has a codoping with cerium.

16. A light-conductive fiber as defined in claim 1, wherein said at least one stress core has a codoping with cerium.

17. A method for producing a light-conducting fiber, comprising a doped monomode core which extends substantially in a longitudinal direction of the fiber; surrounding said monomode core by a pump core which has a noncircular symmetrical cross-section; doping said monomode core with an element selected from the group consisting of neodymium, erbium, thulium, holmium, ytterbium and presidium; and providing a stress core which extends substantially in a longitudinal direction of the fibers and applies forces to the monomode core.

18. A method as defined in claim 17; and further comprising using a quartz fiber with aluminum for adjusting a refraction profile.

19. A method as defined in claim 17; and further comprising doping includes doping with Yb₂O₃.

20. A method as defined in claim 17; and further comprising codoping with Te₂O₃.

21. A method as defined in claim 17; and further comprising doping of the monomode core and codoping with Ce₂O₃.
